(19) United States
(12) Patent Application Publication
(10) Pub. No.: US 2021/0068009 A1
(43) Pub. Date: Mar. 4, 2021

(54) PERFORMANCE INDICATION OF ULTRA-X GRADED CARRIER

(71) Applicant: Nokia Technologies Oy, Espoo (FI)

(72) Inventors: Vinh VAN PHAN, Oulu (FI); Ling YU, Kauniainen (FI)

(21) Appl. No.: 16/960,472

(22) PCT Filed: Jan. 11, 2018
(86) PCT No.: PCT/EP2018/050678

§ 371 Date: Jul. 7, 2020

(51) Int. Cl. H04W 28/24; H04W 4/70; H04W 24/08; H04W 72/12

(52) U.S. Cl. CPC H04W 28/24; H04W 4/70; H04W 72/1236; H04W 72/1284; H04W 24/08

(57) ABSTRACT

It is provided a method, comprising measuring a measured performance level of a downlink carrier of a cell based on a received monitoring configuration; deciding if the downlink carrier fulfills a received decision criterion based on the measured performance level; initiating a handshake with the cell if the downlink carrier fulfills the received decision criterion.

### FIELD OF THE INVENTION

The present invention relates to an apparatus, a method, and a computer program product related to ultra-X graded carriers, in particular in Industry 4.0 networks.

### ABBREVIATIONS

3GPP 3rd Generation Partnership Project
4G/5G 4^{th}/5^{th} Generation
5GC 5G Core Network
ack acknowledgment
CA Carrier Aggregation
C-RNTI Controlling Radio Network Temporary Identity
D2D Device-to-Device (Communication)
DL Downlink
DRX Discontinued Reception
E2E end-to-end (Communication)
eNB evolved NodeB
GBR Guaranteed Bitrate
gNB next generation NodeB
IAC Industry Automation and Control
ID Identifier
IoT Internet of Things
KPI Key Performance Indicator
L1/L2/L3 Layer 1/Layer 2/Layer 3 (of OSI layer model)
LTE Long Term Evolution
MAC Medium Access Control
MBB Mobile Broadband
MC Multi-Connectivity
MIMO Multiple Input-Multiple Output
MTC Machine-type Communication
PCell Primary Cell
PDCCH Physical Downlink Control Channel
PUCCH Physical Uplink Control Channel
RACH Random Access Channel
RAN Radio Access Network
Rel Release
RRC Radio Resource Control
Rx Receive
SA System Architecture
SCell Secondary Cell
SIB System Information Block
SID Study Item
TR Technical Report
TS Technical Specification
TTI Transmission Time Interval
Tx Transmit
UE User Equipment
UL Uplink
URLLC Ultra Reliable Low Latency Communication
Uu Interface between base station and UE

### BACKGROUND OF THE INVENTION

It is intended that 5G supports challenging industrial automation and control (IAC) use cases in 3GPP Rel'15 and beyond. The most recent SA1 SID and draft technical report TS22.804 [1] aims to identify representative vertical use cases and corresponding potential requirements for 5G communication for automation in vertical domains.

It has been established that many IAC use cases require at least one of ultra-high availability, ultra-high reliability or ultra-low latency, commonly referred to herein as ultra-x, support for E2E communications from a serving 5G network [2]. Hence, an ultimate implication is that a corresponding serving radio access carrier or cell provided by a serving RAN of the serving 5G network needs to be able to fulfil the supported ultra-x requirements to such an extent that a relevant UE of a IAC system can be reassured if and how those ultra-x requirements are supported. Specifically, the UE should be reassured of the ultra-x requirements beforehand (i.e., before the UE starts communicating on the carrier) or at least in a proactive manner (i.e., before a UE is negatively impacted by a degradation of the reassured performance). This allows the UE and the belonging IAC system of the UE to determine whether to continue operating or not and to adjust operation mode properly for safety reasons as well as for efficiency and economics reasons.

The studies on URLLC support in 3GPP so far have been focusing on providing RAN capabilities and features to enable URLLC requirements in general, such as flexible TTIs, grant-free uplink transmissions, transmission diversity and redundancy techniques using MIMO, carrier aggregation (CA) or multi-connectivity (MC) for data transmissions of an active UE. The ultra-high availability has not been particularly addressed on RAN. Technical solutions for 5G networks to support ultra-x IAC are still very much open.

It is noted that current cellular networks are designed for MBB support and therefore, no reassured ultra-x requirements are provided, except for guaranteed bit rate (GBR) bearer services. It is further noted that performance monitoring of a targeted characteristic on different levels of the radio protocol stack as well as the transport network according to a set KPI is a known mechanism in general and considered as a common sense or principle. Furthermore, inter-cell and intra-cell radio measurement and reporting for active UE or UE in DRX is also well known.

However, the issues discussed hereinabove for IAC use cases have not been addressed so far, especially when considering supports for inactive UE or idle UE.

### REFERENCES

[1] SP-170169 New SID on Communication for Automation in Vertical Domains
[2] 3GPP TR 22.804 Study on Communication for Automation in Vertical Domains, V0.2.0

### SUMMARY OF THE INVENTION

It is an object of the present invention to improve the prior art.

According to a first aspect of the invention, there is provided an apparatus, comprising at least one processor, at least one memory including computer program code, and the at least one processor, with the at least one memory and the computer program code, being arranged to cause the apparatus to at least perform measuring a measured performance level of a downlink carrier of a cell based on a received monitoring configuration; deciding if the downlink carrier fulfills a received decision criterion based on the measured performance level; initiating a handshake with the cell if the downlink carrier fulfills the received decision criterion.

The at least one processor, with the at least one memory and the computer program code, may be arranged to cause the apparatus to further perform inhibiting the initiating of the handshake if the downlink carrier does not fulfill the received decision criterion.

The at least one processor, with the at least one memory and the computer program code, may be arranged to cause the apparatus to further perform transmitting a scheduling request to the cell if the downlink carrier does not fulfill the received decision criterion; wherein the scheduling request requests the cell to schedule a resource to report the measured performance level.

The at least one processor, with the at least one memory and the computer program code, may be arranged to cause the apparatus to further perform inhibiting the transmitting of the scheduling request if a mode indication is received, wherein the mode indication indicates not to transmit the scheduling request.

The at least one processor, with the at least one memory and the computer program code, may be arranged to cause the apparatus to periodically repeat, with a received checking period, the measuring, the deciding, and, if the downlink carrier satisfies fulfills the decision criterion, the initiating.

The at least one processor, with the at least one memory and the computer program code, may be arranged to cause the apparatus to further perform checking if a terminal to which the apparatus belongs is in an inactive state; wherein the handshake may be initiated by transmitting a layer 1 signature signal if the terminal is in the inactive state.

The at least one processor, with the at least one memory and the computer program code, may be arranged to cause the apparatus to further perform checking if a terminal to which the apparatus belongs is in an idle state; wherein the handshake, may be initiated by transmitting a preamble of a random access procedure or a grant-free message if the terminal is in the idle state.

The measuring of the measured performance level may comprise counting at least one of actually received physical downlink control channel signals and actually received downlink synchronization signals; the decision criterion may comprise at least one of a number of expected received physical downlink control channel signals and a number of expected received downlink synchronization signals, respectively, and the deciding may comprise comparing the number of the actually received physical downlink control channel signals and the number of the actually received downlink synchronization signals, respectively, with the number of the expected received physical downlink control channel signals and the number of the expected received downlink synchronization signals, respectively.

The at least one processor, with the at least one memory and the computer program code, may be arranged to cause the apparatus to perform monitoring if an acknowledgment is received in response to the initiating of the handshake; inhibiting to respond to the acknowledgment if the downlink carrier fulfills the received decision criterion.

The at least one processor, with the at least one memory and the computer program code, may be arranged to cause the apparatus to further perform monitoring if an indication of a reassured performance level of the downlink carrier is received; selecting the downlink carrier for communicating with the cell if the indicated reassured performance level fulfills a given need.

According to a second aspect of the invention, there is provided an apparatus, comprising at least one processor, at least one memory including computer program code, and the at least one processor, with the at least one memory and the computer program code, being arranged to cause the apparatus to at least perform providing a decision criterion to a terminal; providing a monitoring configuration to instruct the terminal to measure a performance level of a downlink carrier to the terminal; monitoring if a handshake invitation is received from the terminal; polling the terminal to provide a measurement report of the measured performance level if the handshake invitation is not received; monitoring if the measurement report is received in response to the polling; updating the decision criterion based on the received measurement report.

The at least one processor, with the at least one memory and the computer program code, may be arranged to cause the apparatus to further perform indicating a checking period to the terminal; wherein the monitoring if the handshake invitation is received and, if the handshake invitation is not received, the polling, the monitoring if the measurement report is received, and the updating may be repeated periodically with the checking period.

Each of the handshake invitations may comprise one of a layer 1 signature signal, a preamble of a random access procedure, and a grant-free message.

The at least one processor, with the at least one memory and the computer program code, may be arranged to cause the apparatus to further perform inhibiting at least one of the polling and the updating if the at least one handshake invitation is received.

The at least one processor, with the at least one memory and the computer program code, may be arranged to cause the apparatus to further perform indicating a reassured performance level of the downlink carrier, wherein the decision criterion corresponds to the reassured performance level.

The monitoring configuration may comprise an instruction to monitor at least one of physical downlink control channel signals and downlink synchronization signals.

The at least one processor, with the at least one memory and the computer program code, may be arranged to cause the apparatus to further perform transmitting a mode indication to the terminal, wherein the mode indication indicates that the terminal is inhibited to request scheduling of a resource to report the measured performance level if the downlink carrier does not fulfill the decision criterion.

The at least one processor, with the at least one memory and the computer program code, may be arranged to cause the apparatus to further perform monitoring a performance of a handshake initiated by the received handshake invitation; deciding if an uplink carrier used by the terminal to transmit the handshake to a base station comprising the apparatus is adequate for a reassured performance level based on the performance of the handshake; updating the reassured performance level of the uplink carrier if the uplink carrier is not adequate; indicating the updated reassured performance level of the uplink carrier.

According to a third aspect of the invention, there is provided a system, comprising a terminal apparatus according to the first aspect and a base station apparatus according to the second aspect; wherein the decision criterion received by the terminal apparatus comprises the decision criterion provided by the base station apparatus; the monitoring configuration received by the terminal apparatus comprises the monitoring configuration provided by the base station apparatus; the handshake invitation received by the base station apparatus initiates the handshake initiated by the terminal apparatus.

According to a fourth aspect of the invention, there is provided a method, comprising measuring a measured performance level of a downlink carrier of a cell based on a received monitoring configuration; deciding if the downlink carrier fulfills a received decision criterion based on the measured performance level; initiating a handshake with the cell if the downlink carrier fulfills the received decision criterion.

The method may further comprise inhibiting the initiating of the handshake if the downlink carrier does not fulfill the received decision criterion.

The method may further comprise transmitting a scheduling request to the cell if the downlink carrier does not fulfill the received decision criterion; wherein the scheduling request requests the cell to schedule a resource to report the measured performance level.

The method may further comprise inhibiting the transmitting of the scheduling request if a mode indication is received, wherein the mode indication indicates not to transmit the scheduling request.

The method may further comprise periodically repeating, with a received checking period, the measuring, the deciding, and, if the downlink carrier satisfies fulfills the decision criterion, the initiating.

The method may further comprise checking if a terminal to which the method belongs is in an inactive state; wherein the handshake may be initiated by transmitting a layer 1 signature signal if the terminal is in the inactive state.

The method may further comprise checking if a terminal to which the method belongs is in an idle state; wherein the handshake may be initiated by transmitting a preamble of a random access procedure or a grant-free message if the terminal is in the idle state.

The measuring of the measured performance level may comprise counting at least one of actually received physical downlink control channel signals and actually received downlink synchronization signals; the decision criterion may comprise at least one of a number of expected received physical downlink control channel signals and a number of expected received downlink synchronization signals, respectively, and the deciding may comprise comparing the number of the actually received physical downlink control channel signals and the number of the actually received downlink synchronization signals, respectively, with the number of the expected received physical downlink control channel signals and the number of the expected received downlink synchronization signals, respectively.

The method may further comprise monitoring if an acknowledgment is received in response to the initiating of the handshake; inhibiting to respond to the acknowledgment if the downlink carrier fulfills the received decision criterion.

The method may further comprise monitoring if an indication of a reassured performance level of the downlink carrier is received; selecting the downlink carrier for communicating with the cell if the indicated reassured performance level fulfills a given need.

According to a fifth aspect of the invention, there is provided a method, comprising providing a decision criterion to a terminal; providing a monitoring configuration to instruct the terminal to measure a performance level of a downlink carrier to the terminal; monitoring if a handshake invitation is received from the terminal; polling the terminal to provide a measurement report of the measured performance level if the handshake invitation is not received; monitoring if the measurement report is received in response to the polling; updating the decision criterion based on the received measurement report.

The method may further comprise indicating a checking period to the terminal; wherein the monitoring if the handshake invitation is received and, if the handshake invitation is not received, the polling, the monitoring if the measurement report is received, and the updating are repeated periodically with the checking period.

Each of the handshake invitations may comprise one of a layer 1 signature signal, a preamble of a random access procedure, and a grant-free message.

The method may further comprise inhibiting at least one of the polling and the updating if the at least one handshake invitation is received.

The method may further comprise indicating a reassured performance level of the downlink carrier, wherein the decision criterion corresponds to the reassured performance level.

The monitoring configuration may comprise an instruction to monitor at least one of physical downlink control channel signals and downlink synchronization signals.

The method may further comprise transmitting a mode indication to the terminal, wherein the mode indication indicates that the terminal is inhibited to request scheduling of a resource to report the measured performance level if the downlink carrier does not fulfill the decision criterion.

The method may further comprise monitoring a performance of a handshake initiated by the received handshake invitation; deciding if an uplink carrier used by the terminal to transmit the handshake to a base station performing the method is adequate for a reassured performance level based on the performance of the handshake; updating the reassured performance level of the uplink carrier if the uplink carrier is not adequate; indicating the updated reassured performance level of the uplink carrier.

Each of the methods of the fourth and fifth aspects may be a method of performance indication.

According to a sixth aspect of the invention, there is provided a computer program product comprising a set of instructions which, when executed on an apparatus, is configured to cause the apparatus to carry out the method according to any of the fourth and fifth aspects. The computer program product may be embodied as a computer-readable medium or directly loadable into a computer.

According to some embodiments of the invention, at least one of the following advantages may be achieved:
UEs are informed beforehand or proactively on supported ultra-x requirements;
Applies to active, inactive, and idle UEs;
high efficiency through reduced signaling effort;
short latency from a degradation of a DL to an adapted indication of the reassured KPI level;
existing mechanisms may be exploited.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1 illustrates a flowchart of an embodiment of the invention involving an inactive UE;

FIG. 2 illustrates a flowchart of an embodiment of the invention involving an idle UE;

FIG. 3 shows an apparatus according to an embodiment of the invention;

FIG. 4 shows a method according to an embodiment of the invention;

FIG. 5 shows an apparatus according to an embodiment of the invention;

FIG. 6 shows a method according to an embodiment of the invention; and

FIG. 7 shows an apparatus according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

Some embodiments of this invention provide a so-called ultra-x graded carrier to support targeted IAC use cases requiring at least one of ultra-high availability, ultra-high reliability or ultra-low latency for E2E communications of corresponding IAC system(s). The focus is on the ultra-x graded cell, operating on an ultra-x graded carrier for providing cellular access for UEs of the targeted IAC system(s). The invention provides a method to enable and facilitate that a relevant UE of an IAC system may be reassured if and how ultra-x requirements are supported by a serving ultra-x graded cell. Specifically, the UE is informed beforehand or at least in a proactive manner, as stated above. The relevant UE may be active, inactive, or idle.

Some embodiments of the invention provide an ultra-x graded carrier/cell for IAC use cases; and a method to enable and facilitate that a relevant UE of a IAC system may be reassured if and how ultra-x requirements are supported by a serving ultra-x graded cell specifically beforehand or at least in a proactive manner.

In the context of the present application, an ultra-x graded carrier is at least characterized as a primary carrier supporting at least cellular access, also referred to as radio access over Uu interface between UE and serving access node or gNB, i.e., providing Pcell as known in LTE/5G CA or MC.

The primary carrier may be associated with a set of one or more pre-configured secondary carriers which provide cellular access via corresponding Scells and/or direct D2D radio access. Some of the secondary carriers may be ultra-x graded carriers but they are not necessarily ultra-x graded carriers. In some embodiments, ultra-x grade (e.g. the 99.999% reliability) may be provided jointly by Pcell and Scell in the way that Pcell and two Scells provide e.g. the error rate of 1% if UE has multi-connectivity to these three cells. Then 99.999% reliability is achieved by duplicate transmission of the messages to/from the three cells.

The primary carrier, together with the associated secondary carriers (if any), provides a reassured ultra-x support for a relevant UE of targeted IAC use cases or systems with reassured KPI levels for current ultra-x supports via explicit indication of one or several levels of specified ultra-x KPIs corresponding to at least one of availability (A), reliability (R) and latency (L) of radio access services that can be provided to at least active and inactive UE in connected state for the current updating cycle (for examples, A of 99.999%; R of 99.999% with L of no less than 10 ms and otherwise R of 99.99%; and the updating cycle is every 100 ms). The reassured KPI levels may be decomposed into elements specific to Pcell and individual associated Scells or across plural associated Scells (if any).

In the context of the present application, inactive UE refers to a UE in connected mode which currently has no user data in L2 and L1 buffers to transmit or receive over Uu, whereas active UE refers to a UE which currently has user data in L2 and/or L1 buffers to transmit or receive over Uu.

The UE may be configured with at least one of active and inactive UE specific radio connection monitoring configurations corresponding to indicated KPI levels, as detailed further below.

Depending on an indicated reassured KPI level of the ultra-x graded carrier, the UE may select the ultra-x graded carrier (i.e.: request for an active or inactive ultra-x support) or refrain from selecting or releasing the ultra-x graded carrier.

UEs in idle state may perform a corresponding method with a specific set of reassured KPI levels and corresponding radio connection monitoring configurations, too, as detailed in the proposed method below. The support for idle UEs may be optional, as the current working assumption in 3GPP is that URLLC support is limited for UEs in connected state.

Hereinafter, the method is described at greater detail for a serving gNB operating an ultra-x graded carrier/cell:
The serving gNB indicates (e.g. in SIB or in another broadcasted message newly defined or modified for that purpose) that the serving cell is an ultra-x graded carrier/cell for targeted ICA use cases and systems. The indication may further include any of the following optional elements. Alternatively, or in addition, the serving gNB may configure these optional elements to relevant UE using dedicated signaling once the UE gets connected to the gNB:
   information of associated secondary carriers/cells (if any);
   reassured KPI levels for current ultra-x supports for UE in connected state;
   radio connection monitoring configurations corresponding to individual indicated KPI levels for UE in connected state (active or inactive);
   reassured KPI levels for current ultra-x supports for UE in idle state;
   one or more radio connection monitoring configurations corresponding to respective one or more indicated KPI levels for UE in idle state.

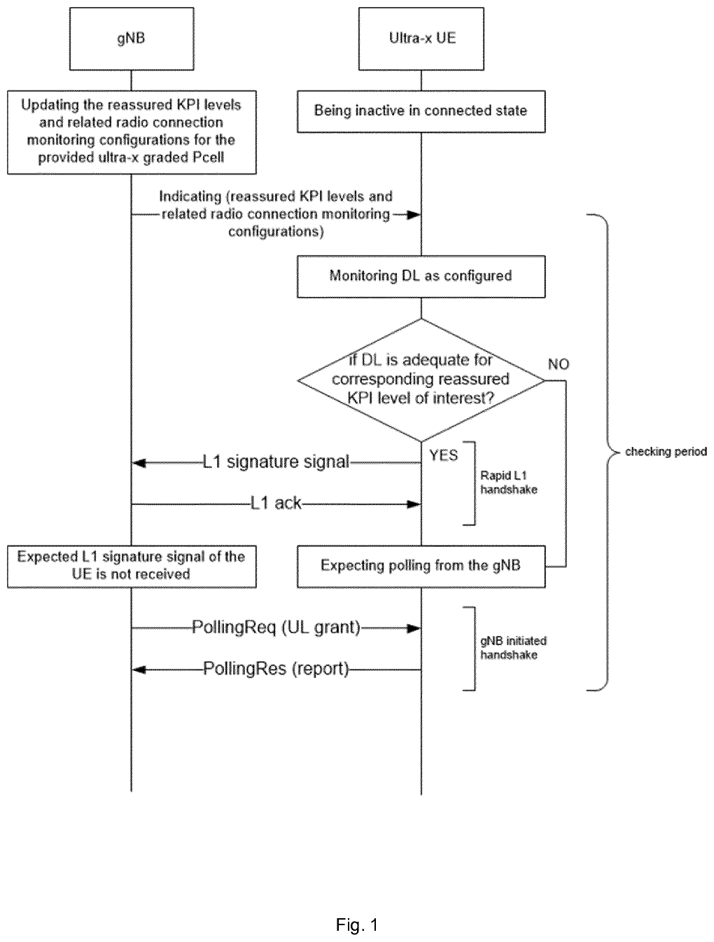

The radio connection monitoring configurations may be as follows:
An inactive UE in connected state (see FIG. 1) is configured with:
   one or more time intervals (also named “checking period(s)”) for periodically monitoring the DL and informing the UE over Uu between the inactive UE and at least one of Pcell and associated Scells (if any) in order to maintain or update the indication of the reassured KPIs provided by gNB and/or a corresponding decision criterion (for examples, a checking period may be 1 ms, 2 ms, 5 ms or 10 ms corresponding to an indicated reassured A and/or R of 99.999% and L of below 10 ms, 10 ms, 20 ms or above 20 ms, respectively); A checking period comprises a time interval for monitoring the DL, and a time interval to decide if the DL is adequate for the indicated reassured KPI level and inform the gNB on the result of the decision. In order to inform the gNB on the decision, a handshake mechanism may be used, as described below.

For example, the monitoring may comprise monitoring DL synchronization signals and PDCCH of the Pcell and, in addition, at least DL synchronization signals of at least one of the associated Scells (if any). The criteria to determine adequacy is configured by the serving network.

For an example, the criteria for A and R of 99.99% may be measured by determining that there are no more than K misses of receiving the DL across the monitored Pcell and Scell(s) per a configured sliding window of N times of the corresponding time interval of periodic handshaking for the radio connection monitoring. For another example, the criteria for A of 99.999% and R of 99.99% may be zero misses of receiving DL synchronization signals of the Pcell and at least one of the associated Scells and no more than K misses of receiving PDCCH in the Pcell over the configured sliding window. In some embodiments, UE may have some expected time slot/TTI in which UE expects the PDCCH transmission instance targeted to the UE for receiving acknowledgment or polling request from gNB. If UE misses receiving such expected PDCCH transmission instances, this kind of missing may weight more than those missed PDCCH transmission instances when UE doesn't expect receiving any targeted PDCCH transmission instance (i.e. the PDCCH transmission instance does not comprise information targeted to the UE in question). The following two paragraphs give examples of untargeted and targeted PDCCH transmission instances.

As an example of an untargeted PDCCH transmission instance, for the DL monitoring of the inactive UE, PDCCH may not need to indicate any scheduling/resource grant related information dedicated to the UE. In this case, UE only used the PDCCH to measure the DL performance as configured.

As an example of a targeted PDCCH transmission instance, in order to reassure the KPI level even more reliable for the UE by DL monitoring of the UE, the serving gNB may configure the inactive UE to monitor PDCCH wherein certain PDCCH instances, e.g. every k-th subframes or time slots, include a UE ID (such as C-RNTI) but without an actual resource allocation information. The other PDCCH instances in between those of k-th subframes do not include the UE specific information. The UE may be configured to select and monitor j instances of PDCCH in between those of k-th subframes, j<k.

If the ultra-X reassurance is related to reliability, the reliability may be determined based on received signal power/quality and/or based on the missed reception of expected messages as explained further below. Then, the error/missing rate may be used to calculate the reliability level, similar as explained above for the availability.

If the ultra-X reassurance is related to latency, a latency measurement may rely on the handshakes between UE and gNB. E.g., one may measure the round-trip time between the handshaking initiation messages transmitted and the handshaking response message received. Thus, one determines the latency of uplink and downlink including some processing time at the UE. One may use the round-trip time in order to estimate the latency of each of the UL ad the DL. E.g. the latency of each of UL and DL may be roughly estimated as 50% (or 45% or 40%) of the measured round-trip time. The latency measurement may be averaged within a certain (preferably sliding) time window.

There may be many other examples of decision criteria.

Some embodiments of the invention provide a novel and efficient handshaking based on both UE initiated and gNB initiated signaling using adaptive formats, as follows:

The inactive UE is configured to initiate sending a configured or predefined L1 signature signal in uplink in at least one of corresponding Pcell and associated Scells (if any) if the UE determines that the DL connection is adequate for the corresponding reassured KPI levels of interest. For example, the inactive UE may transmit the L1 signature signal in PUCCH, RACH, or in a newly designed physical channel.

If the DL connection is not adequate for the corresponding reassured KPI, the inactive UE waits for the Pcell to initiate a polling for more extended handshaking using extended L1, L2 MAC, or L3 RRC signaling. That is, the inactive UE is expected to receive either an acknowledgement of the UE initiated handshake (UL signal: L1 signature signal) or a polling request via an UL allocation in PDCCH of at least the Pcell for the network initiated polling in a specified time slot in the current checking period. In the latter case, the UE replies to the polling by sending extended L1/L2/L3 message reporting comprising the inadequate radio monitoring results which may be common across or specific to the Pcell and at least one of the associated Scells (if any). Pcell or SCell (if any), based on reported radio monitoring results over the current updating cycle of the reassured KPIs, may update and indicate the reassured KPI levels. If the UE is served by PCell and at least one SCell, each of the PCell and SCell(s) may poll the UE to report the respective radio monitoring results.

The inactive UE, depending on the radio link monitoring and updated reassured KPI levels of the serving Pcell may request for stop, reset or reconfiguration of the ultra-x support specific for the UE as well as for the belonging IAC system.

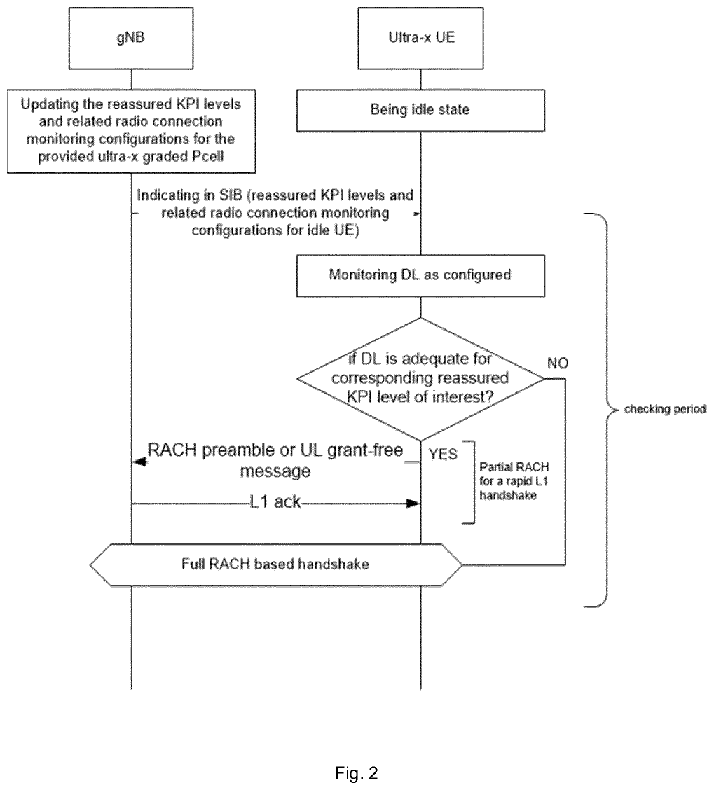

For ultra-x support of idle UEs (see FIG. 2), the procedure for inactive UEs may be modified using UE initiated periodical handshaking with partial RACH or full RACH procedures as follows:

In case the UE determines that the DL is adequate based on similar DL monitoring as described above, the UE initiates a partial RACH procedure for handshaking, stopping at a second RACH message (acknowledgment) received from the gNB in either Pcell or Scell (if any). If the KPI level should be more reliably reassured for the UE, UE specific or dedicated RACH preamble may be used. In an alternative, provided that UL grant free transmission is supported in the serving ultra-x graded carrier, the UE may send an UL grant-free L1 handshaking request message indicating a randomly generated UE ID to the serving gNB, and the gNB may acknowledge the received message in PDCCH using the indicated UE ID. As a still further alternative, idle UE may indicate adequateness in a newly designed physical channel, similar as an inactive UE.

Else, if the UE determines that the DL is not adequate, the full RACH procedure is carried out to report an extended L1/L2/L3 message. In this case, after the reporting, the UE may be kept in connected state or put back to idle mode as determined by the serving network or by the release request from the UE.

In some embodiments, the duration of the checking period is as long as the time duration for monitoring the performance level in a checking period. In these embodiments, the deciding if the measured performance level is adequate and the handshaking of one checking period are performed in parallel to the monitoring of the performance level of the next checking period. That is, a checking period comprises the time duration for the monitoring of one cycle and the deciding and the checking of the previous cycle.

In other embodiments, the time duration for monitoring the performance level is shorter than the duration of the checking period. In these embodiments, the monitoring, deciding, and handshaking of one cycle are performed within one checking period, and only if the handshaking of one cycle is finished, the next checking period starts with a new cycle comprising monitoring, deciding, and handshaking.

The ratio or difference between the time duration for monitoring and the duration of the checking period may be predefined in both gNB and UE. Alternatively, UE may decide on the ratio or difference and inform gNB thereon such that gNB can provide decision criteria adapted to the time duration of the monitoring. For example, the ratio or difference may be predefined in the UE only, or UE may decide on the ratio or difference e.g. based on the current workload. As a further alternative, gNB may inform UE of the ratio or difference under the assumption that each UE is capable to fulfill the monitoring for the time duration, deciding, and handshaking within the duration of the checking period. As a still further alternative, gNB and UE may negotiate the time duration of the monitoring.

Note that for active UEs it is typically assumed that the actual data transmissions overwrite the need to perform the checking (i.e. monitoring, deciding and handshaking) per the configured checking period as compared to inactive UEs. However, active UEs are not prevented from performing the checking.

The following further embodiments are proposed, considering a relevant UE being controlled by a serving gNB using dedicated signaling for a provided ultra-x graded carrier Pcell. The UE, upon selecting an ultra-x graded carrier and requesting a radio connection for an ultra-x service, may be configured with a current set of reassured KPI levels over the current updating interval and radio connection monitoring configurations. The UE then determines if at least one of the indicated KPI levels is adequate for the required QoS of the intended service and proceeds further with either:
placing an active service request if the reassured KPI levels are currently fulfilling all of the requirements; or
placing an inactive service request if the reassured KPI levels are not currently fulfilling all but at least some of the requirements; or else
placing a radio connection release request if the reassured KPI levels are not adequate for all the requirements.

The method described so far uses both UE initiated signaling (L1 signature signal in case of an adequate DL) and gNB initiated signaling (in case of a not adequate DL). As an alternative, in some embodiments, only UE initiated signaling may be used. In such an alternative method, if the UE determines that the DL is not adequate, the UE sends a scheduling request using PUCCH and/or UL grant free transmission. The gNB may allocate an UL grant for the UE to send an extended report message.

As a still other alternative, only gNB initiated signaling may be used. In this alternative, gNB would continuously poll for the latest KPI measurement results.

These alternatives are less efficient than the method described first where the handshaking is based on both UE initiated and gNB initiated signaling (depending on measurement result), because it is expected that in the ultra-x graded carrier the need for gNB initiated handshaking with extended report from UE is rare.

In some embodiments, the radio connection monitoring configuration provided by the gNB may comprise additionally an indication (“mode indication”) of the mode the UE informs the gNB on the result of the decision whether or not the DL is adequate. Namely, the UE may inform the gNB either by UE initiated periodic radio handshakes only, or by network (gNB) initiated periodic radio handshakes only, or by both UE initiated and network initiated periodic radio handshakes depending on the result of the decision. The mode indication may be common across or specific to individuals of Pcell and associated Scells (if any). In some embodiments, the mode the UE informs the gNB is predefined such that the mode indication is not needed.

So far, it is described how UE may determine whether or not the DL is adequate. In some embodiments, in addition, gNB may determine whether or not the UL is adequate. For example, gNB may monitor the radio level of the handshakes described hereinabove. (e.g. L1 signature signal, polling response, and/or corresponding reference signal when polling response message is transmitted in UL, or RACH preambles or other UL message in full RACH procedure). Based on e.g. the number of received L1 message/signals in the monitoring window or the received signaling power or quality, gNB may determine if the UL performance is adequate based on decision criteria corresponding to those used by the UE to determine the DL performance. gNB may indicate the reassured performance level of the DL separately from the reassured performance level of the UL, or it may indicate a combined reassured performance level of both UL ad DL.

FIG. 1 illustrates a flowchart of an embodiment of the invention involving an inactive UE. The handshaking is based on either UE initiated and gNB initiated signaling, depending on the determination if the DL is adequate for the reassured KPI level. That is, the method of FIG. 1 uses both UE initiated signaling (L1 signature signal in case of an adequate DL) and gNB initiated signaling (in case of a not adequate DL).

In detail, gNB indicates its reassured KPI level(s) and related radio connection monitoring configuration(s). Based on the monitoring configuration(s), UE monitors the DL and determines if the DL is adequate for the corresponding reassured KPI level. If the DL is adequate, a rapid L1 handshake is initiated by transmitting a predefined or configured L1 signature signal to the gNB. The gNB acknowledges receipt of the L1 signature signal. Thus, one handshake is performed and the gNB is informed that the DL is adequate. Accordingly, there is no need for the gNB to update the indication of the reassured KPI level.

If, on the other hand, the DL is not adequate, UE does not initiate a handshake by transmitting the predefined L1 signature signal. If gNB does not receive the L1 signature signal within a predefined or configured time after the sliding time window, it polls the UE to report the measured KPI values. For this purpose, gNB provides an uplink grant to UE. In response, UE provides a measurement report. For the purposes of this application, the polling request and polling response may be considered as a gNB initiated handshake.

The checking comprising the monitoring of the DL, the deciding whether or not the DL is adequate, and one of the UE initiated handshake and the gNB initiated handshake may be periodically repeated with the configured checking period.

FIG. 2 illustrates a flowchart of an embodiment of the invention involving an idle UE. FIG. 2 corresponds to FIG. 1, except for the activities after the deciding whether or not the DL is adequate. If the DL is adequate, the UE may initiate a handshake by sending a RACH preamble, the receipt of which may be acknowledged by the gNB, e.g. as conventionally known. However, further RACH messages are not exchanged and the handshake is completed after the acknowledgment by the gNB. On the other hand, if the DL is not adequate, a full RACH procedure is performed such that the UE becomes in connected state and may provide the measurement report to gNB.

The checking comprising the monitoring of the DL, the deciding whether or not the DL is adequate, and one of the partial RACH handshake and the full RACH based handshake may be periodically repeated with the configured checking period.

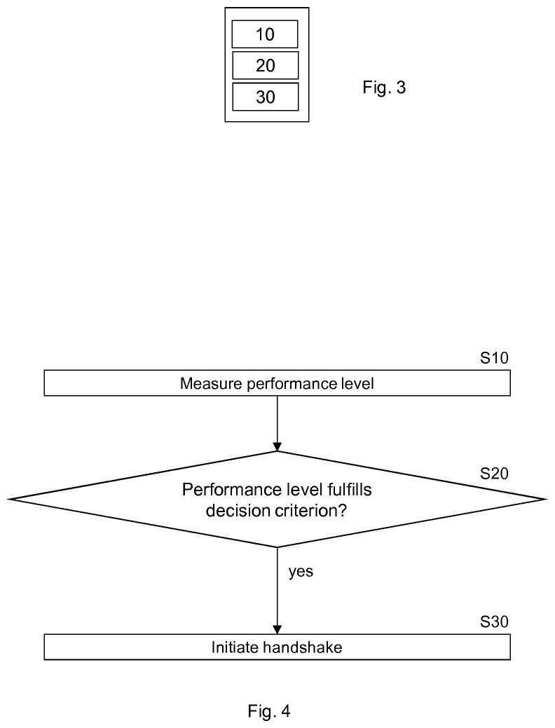

FIG. 3 shows an apparatus according to an embodiment of the invention. The apparatus may be a terminal (such as a UE, an IoT device, or a MTC device) or an element thereof.

FIG. 44 shows a method according to an embodiment of the invention. The apparatus according to FIG. 3 may perform the method of FIG. 4 but is not limited to this method. The method of FIG. 4 may be performed by the apparatus of FIG. 3 but is not limited to being performed by this apparatus.

The apparatus comprises measuring means 10, deciding means 20, and initiating means 30. Each of the measuring means 10, deciding means 20, and initiating means 30 may be a measurement unit, decider, and initiator respectively. Each of the measuring means 10, deciding means 20, and initiating means 30 may be a measuring processor, deciding processor, and initiating processor, respectively.

The measuring means 10 measures a measured performance level of a downlink carrier of a cell based on a received monitoring configuration (S10). The deciding means 20 decides if the downlink carrier fulfills a received decision criterion based on the measured performance level (S20).

If the downlink carrier fulfills the received decision criterion (S20=“Yes”), the initiating means 30 initiates a handshake with the cell (S30) by transmitting a handshake invitation.

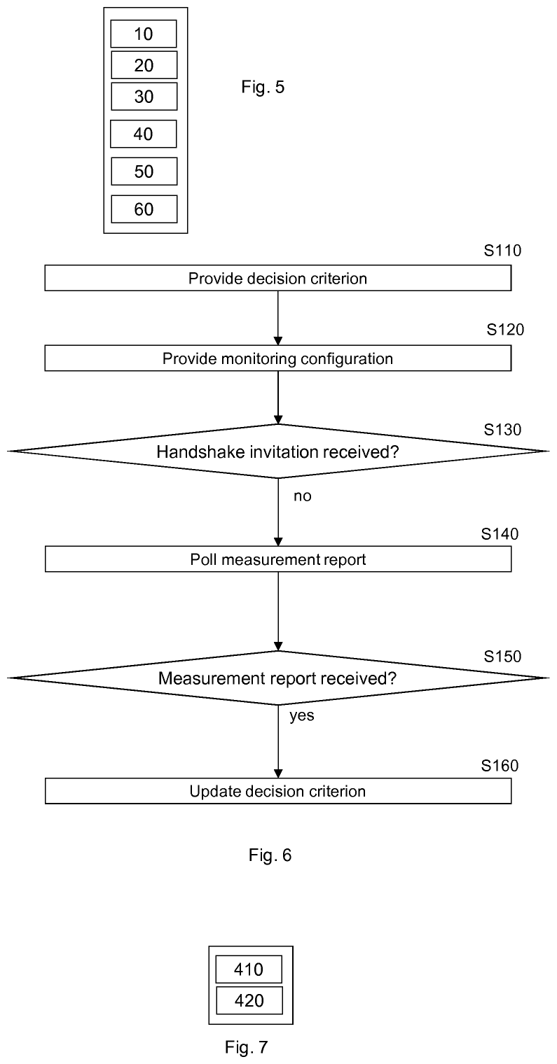

FIG. 5 shows an apparatus according to an embodiment of the invention. The apparatus may be a base station (such as eNB or gNB) or an element thereof. FIG. 6 shows a method according to an embodiment of the invention. The apparatus according to FIG. 5 may perform the method of FIG. 6 but is not limited to this method. The method of FIG. 6 may be performed by the apparatus of FIG. 5 but is not limited to being performed by this apparatus.

The apparatus comprises first providing means 110, second providing means 120, first monitoring means 130, polling means 140, second monitoring means 150, and updating means 160. Each of the comprises first providing means 110, second providing means 120, first monitoring means 130, polling means 140, second monitoring means 150, and updating means 160 may be a first provider, second provider, first monitor, poller, second monitor, and updater, respectively. Each of the comprises first providing means 110, second providing means 120, first monitoring means 130, polling means 140, second monitoring means 150, and updating means 160 may be comprises first providing processor, second providing processor, first monitoring processor, polling processor, second monitoring processor, and updating processor, respectively.

The first providing means 110 provides a decision criterion to a terminal (S110). The second providing means 120 provides a monitoring configuration to instruct the terminal to monitor a performance level of a downlink carrier (S120). The second providing means 120 provides the monitoring configuration to the terminal.

The monitoring means 130 monitors if a handshake invitation is received from the terminal (S130). If the handshake invitation is not received (S130=“No”), the polling means 140 polls the terminal to provide a measurement report corresponding to the monitoring configuration (S140).

The second monitoring means 150 monitors if the measurement report is received in response to the polling (S150). If the measurement report is received (S150=“Yes”), the updating means 160 updates the decision criterion based on the received measurement report (S160).

FIG. 7 shows an apparatus according to an embodiment of the invention. The apparatus comprises at least one processor 410, at least one memory 420 including computer program code, and the at least one processor 410, with the at least one memory 420 and the computer program code, being arranged to cause the apparatus to at least perform the method according to one of FIGS. 4 and 6.

Embodiments of the invention are explained with respect to a UE. A UE is an example of a terminal. Other types of terminals are e.g. MTC devices or IoT devices.

The IAC use cases and systems according to some embodiments of the invention may use different packet sizes or data rates for different kinds of IAC messages. Hence, the reassured KPI levels may also be related/associated to different packet sizes or data rates.

Furthermore, the reassured KPI levels, decision criteria, and corresponding radio monitoring configurations may be indicated to relevant UE(s) using either common signaling (broadcast, e.g. SIB) or dedicated signaling (scheduled specifically to the UE). If it is intended that an idle UE performs the method of the invention, the decision criteria have to be indicated using common signaling. Whether to use common signaling or dedicated signaling for inactive UEs may be flexibly decided by the serving gNB. For example, the decision criteria indicated using common signaling may be also linked to some certain UE categories (in addition to UE states or conditions). The UE categories may be related to the UE capabilities (e.g., Rx, Tx, D2D or SideLink, MC, etc.), UE types (e.g., sensor, actuator, etc.), UE locations (e.g., cell center/cell edge or different zones within the cell, etc.).

In some embodiments of the invention, only a subset of the UEs performs a method of the invention to monitor the performance level of the ultra-x graded carrier and to inform the cell on it such that the cell may update the indication of the reassured KPI level. Other UEs may only monitor the reassured KPI level indicated by the cell and select or deselect the ultra-x graded carrier depending on the indicated reassured KPI level without contributing to the checking beyond the conventional reporting of performance data.

In some embodiments of the invention, a UE may perform a method of the invention to update the indication of the reassured KPI without selecting a carrier according to the reassured KPI level. Thus, it supports IAC use cases without benefitting directly therefrom. These UEs do not need to monitor the indication of the reassured KPI level provided by the cell. It is sufficient that they get the decision criterion (criteria) to decide if the measured performance level is adequate.

One piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

According to the above description, it should thus be apparent that example embodiments of the present invention provide, for example, a terminal such as a UE, a MTC device, an IoT device etc, or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, a base station such as a eNB or a gNB, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1. An apparatus, comprising at least one processor, at least one memory including computer program code, and the at least one processor, with the at least one memory and the computer program code, being arranged to cause the apparatus to:
measure a measured performance level of a downlink carrier of a cell based on a received monitoring configuration;
decide if the downlink carrier fulfills a received decision criterion based on the measured performance level; and
initiate a handshake with the cell if the downlink carrier fulfills the received decision criterion and inhibit the initiating of the handshake and transmit a scheduling request to the cell if the downlink carrier does not fulfill the received decision criterion.

2. (canceled)

3. The apparatus according to claim 1, wherein
the scheduling request requests the cell to schedule a resource to report the measured performance level.

4. The apparatus according to claim 3, wherein the at least one processor, with the at least one memory and the computer program code, is arranged to further cause the apparatus to:
inhibit the transmitting of the scheduling request if a mode indication is received, wherein
the mode indication indicates not to transmit the scheduling request.

5. The apparatus according to claim 1, wherein the at least one processor, with the at least one memory and the computer program code, is arranged to cause the apparatus to periodically repeat, with a received checking period, the measuring, the deciding, and, if the downlink carrier satisfies fulfills the decision criterion, the initiating.

6. The apparatus according to claim 1, wherein the at least one processor, with the at least one memory and the computer program code, is arranged to further cause the apparatus to:
check if a terminal to which the apparatus belongs is in an inactive state, wherein
the handshake is initiated by transmitting a layer 1 signature signal if the terminal is in the inactive state.

7. The apparatus according to claim 1, wherein the at least one processor, with the at least one memory and the computer program code, is arranged to further cause the apparatus to:
check if a terminal to which the apparatus belongs is in an idle state, wherein
the handshake is initiated by transmitting a preamble of a random access procedure or a grant-free message if the terminal is in the idle state.

8. The apparatus according to claim 1, wherein:
the measuring of the measured performance level comprises counting at least one of actually received physical downlink control channel signals and actually received downlink synchronization signals;
the decision criterion comprises at least one of a number of expected received physical downlink control channel signals and a number of expected received downlink synchronization signals, respectively, and
the deciding comprises comparing the number of the actually received physical downlink control channel signals and the number of the actually received downlink synchronization signals, respectively, with the number of the expected received physical downlink control channel signals and the number of the expected received downlink synchronization signals, respectively.

9. The apparatus according to claim 1, wherein the at least one processor, with the at least one memory and the computer program code, is arranged to further cause the apparatus to:
monitor if an acknowledgment is received in response to the initiating of the handshake; and
inhibit to respond to the acknowledgment if the downlink carrier fulfills the received decision criterion.

10. The apparatus according to claim 1, wherein the at least one processor, with the at least one memory and the computer program code, is arranged to further cause the apparatus to:
monitor if an indication of a reassured performance level of the downlink carrier is received; and
select the downlink carrier for communicating with the cell if the indicated reassured performance level fulfills a given need.

11. An apparatus, comprising at least one processor, at least one memory including computer program code, and the at least one processor, with the at least one memory and the computer program code, being arranged to cause the apparatus to:
provide a decision criterion to a terminal;
provide a monitoring configuration to instruct the terminal to measure a performance level of a downlink carrier to the terminal;
monitor if a handshake invitation is received from the terminal;
poll the terminal to provide a measurement report of the measured performance level if the handshake invitation is not received;
monitor if the measurement report is received in response to the polling; and
update the decision criterion based on the received measurement report.

12. The apparatus according to claim 11, wherein the at least one processor, with the at least one memory and the computer program code, is arranged to further cause the apparatus to:
indicating indicate a checking period to the terminal, wherein
the monitoring if the handshake invitation is received and, if the handshake invitation is not received, the polling, the monitoring if the measurement report is received, and the updating are repeated periodically with the checking period.

13. The apparatus according to claim 11, wherein each of the handshake invitations comprises one of a layer 1 signature signal, a preamble of a random access procedure, and a grant-free message.

14. The apparatus according to claim 11, wherein the at least one processor, with the at least one memory and the computer program code, is arranged to further cause the apparatus to:
inhibit at least one of the polling and the updating if the at least one handshake invitation is received.

15. The apparatus according to claim 11, wherein the at least one processor, with the at least one memory and the computer program code, is arranged to further cause the apparatus to:
indicate a reassured performance level of the downlink carrier, wherein the decision criterion corresponds to the reassured performance level.

16. The apparatus according to claim 11, wherein the monitoring configuration comprises an instruction to monitor at least one of physical downlink control channel signals and downlink synchronization signals.

17. The apparatus according to claim 11, wherein the at least one processor, with the at least one memory and the computer program code, is arranged to further cause the apparatus to:
transmitting a mode indication to the terminal, wherein the mode indication indicates that the terminal is inhibited to request scheduling of a resource to report the measured performance level if the downlink carrier does not fulfill the decision criterion.

18. The apparatus according to claim 11, wherein the at least one processor, with the at least one memory and the computer program code, is arranged to further cause the apparatus to:
monitor a performance of a handshake initiated by the received handshake invitation;
decide if an uplink carrier used by the terminal to transmit the handshake to a base station comprising the apparatus is adequate for a reassured performance level based on the performance of the handshake;
update the reassured performance level of the uplink carrier if the uplink carrier is not adequate; and
indicate the updated reassured performance level of the uplink carrier.

19. (canceled)

20. A method, comprising:
measuring a measured performance level of a downlink carrier of a cell based on a received monitoring configuration;
deciding if the downlink carrier fulfills a received decision criterion based on the measured performance level; and
initiating a handshake with the cell if the downlink carrier fulfills the received decision criterion and inhibiting the initiating of the handshake and transmit a scheduling request to the cell if the downlink carrier does not fulfill the received decision criterion.

21. (canceled)

22. The method according to claim 21, wherein:
the scheduling request requests the cell to schedule a resource to report the measured performance level.

23-29. (canceled)

30. A method, comprising:
providing a decision criterion to a terminal;
providing a monitoring configuration to instruct the terminal to measure a performance level of a downlink carrier to the terminal;
monitoring if a handshake invitation is received from the terminal;
polling the terminal to provide a measurement report of the measured performance level if the handshake invitation is not received;
monitoring if the measurement report is received in response to the polling; and
updating the decision criterion based on the received measurement report.

31-39. (canceled)
